(19) United States
(12) Patent Application Publication
(10) Pub. No.: US 2011/0099421 A1
(43) Pub. Date: Apr. 28, 2011

(54) RADIATION-HARDENED HYBRID PROCESSOR

(76) Inventors: Alessandro Geist, Bethesda, MD (US); Thomas P. Flatley, Hungtington, MD (US); Michael R. Lin, Ellicott City, MD (US); David J. Petrick, Severna Park, MD (US)

(21) Appl. No.: 12/854,490

(22) Filed: Aug. 11, 2010

Related U.S. Application Data
(63) Continuation-in-part of application No. 12/570,134, filed on Sep. 30, 2009.

(51) Int. Cl. G06F 11/16

(52) U.S. Cl. 714/10; 714/E11.061

(57) ABSTRACT

A processing system having a small form factor and configured to connect to an external platform. The processing system includes input interfaces configured to receive an input signal to be processed; a radiation tolerant field programmable gate array including processors configured to process the input signal; memory containing reconfigurable instructions for the processors that, when the reconfigurable instructions are executed, process the input signal and obtain the output signal; output interfaces configured to send the output signal to the external platform; and a reset logic element configured to selectively reset the field programmable gate array and at least one of the processors in response to a reset command. The input interfaces include at least one gigabit Ethernet interface and at least one space-rated balanced voltage digital interface circuit. The output interfaces include at least one serial advanced technology attachment interface and at least one space-rated balanced voltage digital interface circuit.

### INTRODUCTION

This patent application is a continuation-in-part of U.S. patent application Ser. No. 12/570,134, filed Sep. 30, 2009, titled “Radiation-hardened hybrid processor,” the entire content of which is incorporated by reference herein.

### ORIGIN OF THE INVENTION

The invention described herein was made by an employee of the United States Government, and may be manufactured and used by or for the Government for governmental purposes without the payment of any royalties thereon or therefor.

### FIELD

The present teachings relate to a′ processing system including a CPU, FPGA, and DSP processing elements providing high performance and low power consumption in a compact form factor. In some embodiments, radiation hardening by design and software can be employed to provide reliability close to that of a radiation-hardened processor.

### BACKGROUND

Modern electronic devices utilize computational components to carry out various functions that are necessary to or that enhance the device's functionality. The computational components can be in the form of circuit boards, wired-in processors, or other fixed or removable elements containing components that carry out computations, data processing, and other functions.

Electronic devices can be designed to operate in hostile environments, meaning environments that can negatively affect the functioning of the devices. For example, hostile environments can include radiation or other conditions that are known to negatively affect the performance of the devices. It is thus useful to provide radiation-hardening for computational components to prevent and/or mitigate data errors and computational component failures due to radiation and other effects.

Three levels of processor or component radiation tolerance are known to exist. The first level is an unprotected component, which can experience both recoverable errors (e.g., bit flips) and destructive errors when utilized in a hostile environment. The second level is commonly referred to as radiation tolerant, and is designed such that destructive errors are avoided in hostile environments, but recoverable errors such as bit flips may still occur. The third level is commonly referred to as radiation hardened, and experiences neither recoverable nor destructive errors when utilized in a hostile environment. The processing power of radiation hardened processors tends to be less than commercially-available non-radiation-hardened processors. The processing power of a radiation-hardened processor can be, for example, one or two generations behind commercially-available non-radiation-hardened processors.

It is beneficial to be able to use commercially-available computational components with current-generation processing power that can easily be added to existing or to new platforms without having to custom design the computational components. It is also beneficial to provide standard interfaces and communication protocols to the computational components, so that one, or more computational components can be easily added to a standard platform, as needed, to increase the computing power of the platform.

### SUMMARY

The present teachings provide a processing system having a small form factor and configured to connect to an external platform. The processing system includes input interfaces configured to receive an input signal to be processed; a radiation tolerant field programmable gate array including processors configured to process the input signal; memory containing reconfigurable instructions for the processors that, when the reconfigurable instructions are executed, process the input signal and obtain the output signal; output interfaces configured to send the output signal to the external platform; and a reset logic element configured to selectively reset the field programmable gate array and at least one of the processors in response to a reset command. The input interfaces include at least one gigabit Ethernet interface and at least one space-rated balanced voltage digital interface circuit. The output interfaces include at least one serial advanced technology attachment interface and at least one space-rated balanced voltage digital interface circuit.

The present teachings also provide a method of providing increased processing power for a backward-compatible processing system having a small form factor. The processing system is configured to connect to an external platform. The method includes: providing a first memory and a second memory; providing a radiation tolerant field programmable gate array having two processors; receiving data from the external platform using at least one gigabit Ethernet interface and at least one space-rated balanced voltage digital interface circuit; processing the data from the external platform according to instructions stored in the first memory; and outputting the processed data using at least one serial advanced technology attachment interface and at least one space-rated balanced voltage digital interface circuit.

The present teachings further provide a processing payload for a sounding rocket. The processing payload includes a processing system having a small form factor and including input interfaces configured to receive an input signal to be processed, the input interfaces including at least one gigabit Ethernet interface and at least one space-rated balanced voltage digital interface circuit; a radiation tolerant field programmable gate array including processors configured to process the input signal; memory containing reconfigurable instructions for the processors that, when the reconfigurable instructions are executed, process the input signal and obtain the output signal; output interfaces configured to send the output signal to the external platform, the output interfaces including at least one serial advanced technology attachment interface and at least one space-rated balanced voltage digital interface circuit; and reset logic configured to selectively reset the field programmable gate array and at least one of the processors in response to a reset command.

Objects and advantages of the present teachings will be obvious from the description, or may be learned by practice of the teachings. The objects and advantages can be realized and attained by means of the elements and combinations particularly pointed out in the appended claims.

It is to be understood that both the foregoing general description and the following detailed description are exemplary and explanatory only and are not restrictive of the present teachings, as claimed.

The accompanying drawings, which are incorporated in and constitute a part of this specification, illustrate embodiments of the present teachings and, together with the description, serve to explain the principles of the present teachings.

### BRIEF DESCRIPTION OF THE DRAWINGS

Exemplary embodiments of the present teachings are described below with reference to the appended drawings, in which:

FIG. 1 is a schematic diagram showing elements of a processing system according to an embodiment of the present teachings;

FIG. 2 is a schematic diagram showing elements of a processing system according to an embodiment of the present teachings;

FIG. 3 is a schematic diagram showing a parallel connection of a processing system according to an embodiment of the present teachings;

FIG. 4 is a schematic diagram showing an in-line connection of a processing system according to an embodiment of the present teachings;

FIG. 5 is a schematic diagram showing an exemplary embodiment of a memory map I/O for an embodiment of a processing system in accordance with the present teachings; and

FIG. 6 illustrates an exemplary implementation of a processing system of the present teachings utilized in a sounding rocket payload.

### DETAILED DESCRIPTION

Embodiments of the present teachings disclosed herein provide a processing system including a field-programmable gate array (FPGA), for example, a radiation-tolerant FPGA, which can be added to an existing platform to increase its computational performance without the need to design and test a customized processor. An in-flight reprogrammable and/or reconfigurable logic structure can provide the ability to change the operation of the processing system after assembly of the processing system in a platform, and/or after deployment of the platform.

A processing system according to the present teachings can include a FPGA, such as a radiation-tolerant FPGA, configured to operate in a radioactive environment with minimal errors in data being processed.

In accordance with various embodiments of the present teachings, radiation hardening by design can be obtained by having a FPGA of the processing system process two identical sets of data concurrently and compare the data to identify possible errors (inconsistent data). Any detected errors in the data can be mitigated. Such a comparison and mitigation can provide a radiation hardening by software scheme to mitigate the majority of errors. In the context of the present teachings, radiation hardening by software refers to executing functions or software applications to identify radiation-induced errors occurring in processors and taking appropriate corrective action.

Processing systems are employed in various devices, from scientific instrument platforms to consumer products, to perform various functions that enhance the devices' utility. Processing systems can control operation of the device or platform of which they are a part, can carry out data processing and manipulation, and/or can control communication with a remote station. The addition of computing power to a device can typically be simplified by using commercially-available, current-generation standardized processors that can be added as desired to various different platforms by using standard connections and protocols.

Commercially-available, current-generation standardized processors can be utilized in processing systems and can be added or removed from electronic devices as necessary to provide a desired level of computing performance. In the context of the present teachings, a processing system can include an element that can be added and removed from a device to provide functionality, for example, computing power, without the need to customize the element. The processing system can also provide the ability to easily exchange parts of a device, such as replacing an older CPU with a newer model, without having to redesign the parts or the device.

The processing system is preferably configured to withstand hostile environmental conditions. As stated above, bombardment by neutrons, gamma rays, alpha particles, and other particles and electromagnetic waves can cause damage (i.e., destructive errors) to the processing system or transient errors (e.g., bit flips) in CPUs and memory elements. Devices designed for use in space are particularly subject to damage and errors from radiation, due to the strong radiation fields present outside the Earth's atmosphere. In addition, many other sensor platforms, instruments, and other devices can be subject to similar damage from natural or man-made radiation.

In accordance with various embodiments of the present teachings, the processing system employs a programmable FPGA processor including a CPU and a DSP, such as a Xilinx® Virtex-5 FX100T FPGA, which is a non-space-rated FPGA including two IBM® PowerPC® processors. A space-rated FPGA such as, for example, a Xilinx® Virtex FX130 FPGA (presently being prototyped), can alternatively be employed in accordance with the present teachings, and can provide a space-rated or almost space-rated radiation-hardened FPGA with two IBM® PowerPC® processors. Alternatively, 6-series or 7-series Xilinx® Virtex FPGAs can be employed.

In accordance with exemplary embodiments of the present teachings, the processing system can include one or more processors, CPUs, or other computational engines, one or more memory elements containing instructions to be executed, and communication facilities to connect with the platform, with the outside world, and/or with additional processing systems. A power distribution network can also be included in the processing system, for example, to route and condition power from the external platform to the processing system's various elements.

The processing system can be programmed to perform one or more particular desired functions prior to being connected to a receiving device or platform, but preferably is field programmable and reprogrammable. Thus, once connected to the receiving device or platform, the processing system is configured to be programmed and/or configured (or reprogrammed/reconfigured) as needed. In some embodiments, changes to the programming and configuration of the processing system can be carried out after the receiving device or platform has been deployed as will be explained in more detail below. The FPGA can, for example, reconfigure itself using a multi-boot feature of its configuration memory to update/modify the algorithms and processing it can perform. Thus, the FPGA could be reconfigured on the fly to perform multiple functions in a single mission.

One exemplary application of a processing system, according to the present teachings is in remote platforms carrying science instruments that are capable of acquiring large quantities of data that has to be transmitted to a distant station or stored (and perhaps processed) on board. An example of this arrangement is found in a rocket balloon flight, an unmanned air vehicle (UAV), a miniaturized satellite for space research (e.g., a CubeSat), or a sounding rocket sending data back to Earth, for example on a Terrier Improved-Orion sounding rocket. The data transmission step may be difficult or expensive in terms of power required, available bandwidth, usable connection time, or other parameters. Data storage can be limited by the available memory. The sensors used in a rocket balloon or sounding rocket mission can include, for example, cameras such as an analog video system (e.g., a RocketCam™) and one or more Gigabit Ethernet (GigE) industrial cameras, an inertial measurement unit (IMU), a global positioning system (GPS) and environmental sensors including pressure sensors, thermal sensors, accelerometers, and other sensors that can be utilized include synthetic aperture radar, hyper-spectral instruments, and other instruments to monitor weather, environmental trends, global warming, and other parameters.

In one exemplary embodiment, a processing system in accordance with the present teachings can be employed on a sounding rocket to receive data from a RocketCam™ and two GigE industrial cameras, an IMU, a GPS, a pressure sensor, a thermal sensor, and an accelerometer. The cameras can be employed to validate interfaces and document flight and parachute deployment. Telemetry data can be stored in the processing system and/or transmitted to a distant station (e.g., a control center on Earth). In certain embodiments, the stored and transmitted data can be compressed before storage/transmission, for example. In certain embodiments, transmission of the telemetry data is accomplished via a 10 Mb/s transponder. The FPGA of the processing system can include data compression software, which can, for example, be instrument-specific and accomplish data compression without loss of data integrity.

Because science instruments have high processing requirements and may not be as critical as, for example, safety systems, it can be acceptable to give up some reliability for increased processing power with respect to gathering and processing of science instrument data, for example, in smaller scale and responsive missions, such as short duration suborbital, near-space, and orbital flights. It therefore may be desirable to employ commercially-available processors that are not fully radiation hardened (but that are preferably radiation tolerant) to realize increased processing power, even if some non-destructive errors such as bit flips may occur. Various embodiments of the present teachings can employ radiation hardening by software and/or by design to increase the reliability of such powerful commercially-available radiation tolerant processors.

In certain devices or platforms utilizing a processing system in accordance with the present teachings, transmitting or storing all of the data generated by the sensors on the device or platform may not be practical, and an arrangement where some or most of the data processing is carried out before transmission or storage may be advantageous to reduce the amount of data that will need to be transmitted or stored. Thus, the present teachings contemplate one or more of storing/transmitting raw data, compressed data, and/or raw data.

Although the embodiments of the present teachings are described herein primarily in terms of sensors used in rocket balloons, sounding rockets, and space exploration probes, other applications that can benefit from the present teachings can be envisioned by those skilled in the art and are contemplated by the present teachings. For example, deep sea probes, platforms used in nuclear reactors, and sensor platforms used in other natural and man-made hostile environments present many of the same challenges as instruments used in space probes, and can benefit from the solutions provided by the present teachings.

Processing systems having a modular architecture as set forth in the present teachings can be added to a variety of devices or platforms without being custom-designed. Thus, the processing systems may be used as “off the shelf” units that can be easily added to an instrument platform, communication unit, navigation unit, or other device or platform requiring computing power. In certain embodiments, addition of a processing system can be accomplished simply by providing the appropriate data and power connections and by programming/configuring the processing system appropriately. Further, in various embodiments, multiple processing systems can be “stacked” to provide a customized amount of processing power, memory, and mission specific functions. If a greater amount of computing power is desired, more than one processing system in accordance with the present teachings can be connected to (or “stacked on”) the device or platform. In various embodiments of the present teachings, it is possible to retrofit one or more processing system to older devices to increase their usefulness.

According to certain embodiments of the present teachings, the processing system is able to detect and mitigate errors due to radiation damage at least via radiation hardening by software and design. Radiation hardening by design can ensure that data processing carried out by the processing system is lossless, in that erroneous processed data is not generated or output, and that desired information in the original data can be retrieved after processing. Radiation hardening according to various embodiments of the present teachings can be achieved in two steps. In one step, a processor (e.g., a FPGA) is configured to provide radiation hardening by design of its programmable logic. In a second step, radiation hardening by software is provided to correct or prevent any data errors that may still exist. Various methods, described in greater detail below, can be utilized in accordance with the present teachings to mitigate errors while limiting the computational overhead required for such mitigation.

When a processing system in accordance with the present teachings is used in a sounding rocket, it can have sufficient processing power to process certain data before the data is stored or transmitted to Earth. Certain embodiments of the processing system can perform one or more of: (1) selecting data to transmit; (2) prioritizing data; (3) compressing data; and (4) otherwise manipulating data from the sensor platform before the data is transmitted or stored on board. Due to its modular design, the processing system can be added to a sounding rocket or other spacecraft platform without the need to design platform-specific components.

In accordance with various embodiments of the present teachings, one or more processing systems can be added (or “stacked”), as necessary, to obtain a desired computational performance, sufficient for example to process and store large quantities of data produced by employed sensors. On-board lossless data reduction that can optionally be provided by a processing system can bring about the migration of typical ground-based processing functions to the probe's sensor platform, resulting in a significant reduction in on-board data storage and transmission requirements.

To achieve these and other benefits, embodiments of the processing system have the ability to be “reconfigured on the fly,” meaning that at least some of the processing system's software applications, logic structure, and/or other aspects of its configuration can be modified after manufacture to define how the processor will work. A FPGA such as a Xilinx® Virtex-5 FX100T FPGA can typically allow reconfiguration on the fly. In such a FPGA, containing embedded processors such as PowerPC® processors, radiation-induced upsets may still affect the embedded processors and associated memory, and cause single-event upsets such as bit-flips. Critical upsets, however, can be substantially prevented by using a radiation tolerant FPGAs and logic, providing a first step in radiation hardening.

The second radiation hardening step can include radiation hardening by software to mitigate the effects of possible single-event upsets (e.g., bit flips) caused by radiation. For example, radiation hardening by software includes providing data corruption indicia to identify incorrect results of computations carried out in the embedded processors, and causing the computations to be repeated when necessary due to incorrect results. Incorrect results can be identified by having the two embedded PowerPC processors output the same data or run the same computations on the same data and output computation results. The output of the two processors should be the same. The output is compared by one of the processors and, if the output of the two processors is not the same, an error is assumed and mitigated. Mitigation can include, for example, re-running computations in the two processors and re-comparing data until the output of the two processors is the same.

As will be understood by those skilled in the art, the data corruption indicia can include a scrubber function, a checksum function, error detection and correction (EDAC), or other known methodologies to rapidly determine whether two computations give identical results. A checksum can include a fixed-size datum computed from an arbitrary block of data for the purpose of detecting errors that may have been introduced during transmission or storage of the data. Integrity of the data can be checked at any later time by re-computing the checksum and comparing it with the stored one. If the checksums do not match, the data was altered. Error detection and correction can include techniques that enable reliable delivery of data over unreliable communication channels. Upon detection of an error in the data, reconstruction of the original, error-free data can take place.

To perform error checking, a dedicated memory of the processing system can be used to store programming instructions that, when executed by a processor, result in at least a part of the radiation hardening by software procedure. Alternatively, programming instructions may be provided when reconfiguring the device. The programming instructions can be stored at least in part in other memory components of the processing system according to embodiments of the present teachings.

Verifying data corruption indicia utilizing certain embodiments of the present teachings requires only two processors (e.g., two PowerPC® processors on a Xilinx® Virtex® FPGA) to carry out identical computations and verify the results. This compares well with the at least three processors necessary in a conventional redundant apparatus with an arbiter circuit. Instead of executing three identical computations and discarding the one that gives a different result, the present teachings envision comparing the checksums (or other data corruption indicia) of two identical computations, and repeating the computation if the checksums are different.

Compared to a present state of the art radiation hardened processor, such as the BAE Systems RAD750, embodiments of a processing system according to the present teachings can provide up to approximately 100 times the processing power, and mitigation of radiation errors that are essentially as effective as that of the state of the art. This is obtained at a fraction of the cost and time involved in developing a radiation hardened processor dedicated to a specific application.

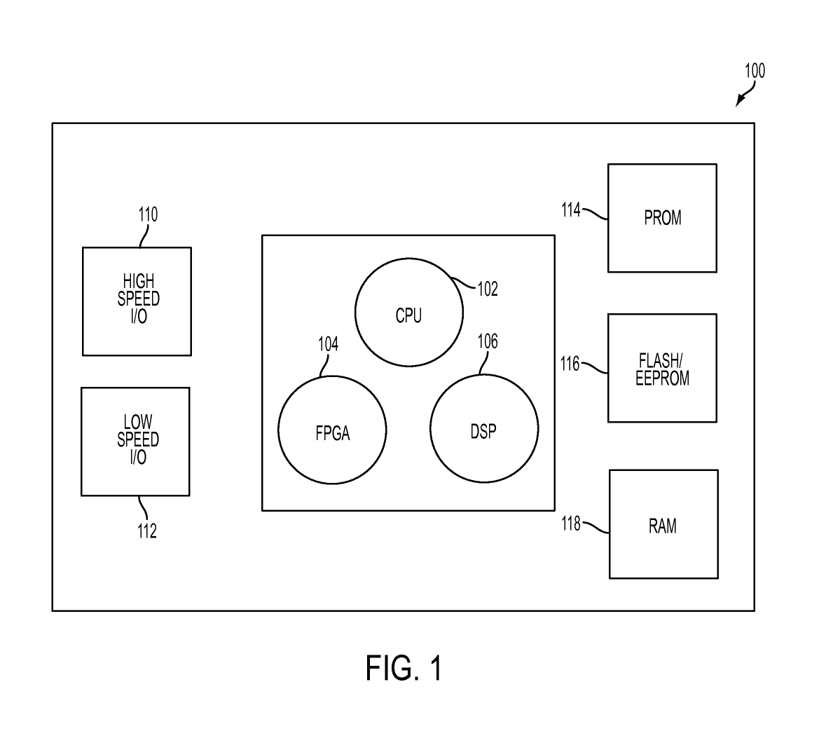

FIG. 1 is a schematic diagram of an exemplary embodiment of a processing system 100 according to the present teachings. The exemplary processing system 100 includes a CPU 102, a FPGA 104 and digital signal processing (DSP) element 106. In certain embodiments, the CPU 102 can include one or more PowerPC® processors or another processor that is suitable for embedding in a computational device.

As stated above, the FPGA 104 can include a Xilinx® Virtex or other suitable FPGA. In certain embodiments, the FPGA 104 includes two or more processors, such as PowerPC® processors, which can be mounted, for example, in a back-to-back configuration to minimize the space and volume of the installation and obtain computational efficiencies. In certain embodiments, the FPGA is radiation tolerant to prevent or mitigate errors and data loss in radioactive environments. Those of ordinary skill in the art will understand that configurable architectures other than FPGAs can be used in accordance with the present teachings, such as software-configurable microprocessors and other reconfigurable systems.

The digital signal processor (DSP) 106 can be configured to carry out digital processing of signals including, for example, data generated by a sensor platform, which data can be processed or otherwise manipulated before being stored in memory and/or transmitted to a distant station. The DSP 106 can, for example, carry out analysis, compression, selection, or other processes that can reduce the amount of information stored or transmitted over a data link. Additional functions can be carried out by the DSP 106, as directed by the FPGA or by instructions from outside the device.

One or more high speed I/O connections 110 and, in certain embodiments, one or more low speed I/O connections 112 can be provided in an embodiment of the processing system 100 to integrate the processing system 100 with the data flow of the platform. For example, the I/O connections 110, 112 can support a variety of formats and specifications adapted to a specific mission of the device. These can include “plug and play” Gigabit interfaces such as, for example, serial interfaces such as Serial Advanced Technology Attachment (SATA) or Ethernet. Legacy interfaces can also be employed to provide backward compatibility, including, for example, balanced voltage digital interface circuit such as space-rated RS-422 interfaces for transmission and receipt.

A PROM 114 can be provided in the exemplary processing system 100 for CPU boot, health and safety, and basic command and telemetry functions. The PROM can include, for example, a Xilinx® platform Flash XL. RAM memory 118 can be included for program execution and can include, for example, one or more multi-gigabit DDR2 SDRAM. Flash/EEPROM memory 116 can be used to store algorithms, instructions, and application code for the CPU 102, FPGA 104, and DSP 106. The Flash/EEPROM can include, for example, a 4 Gigabit Flash that can be, for example, space rated. Instructions to carry out radiation hardening by software can be stored in one or more of the above memories. Those of skill in the art will understand that other components and different configurations may be used to achieve the ability to reconfigure the device, and to update, modify, and/or replace algorithms at any point during a mission.

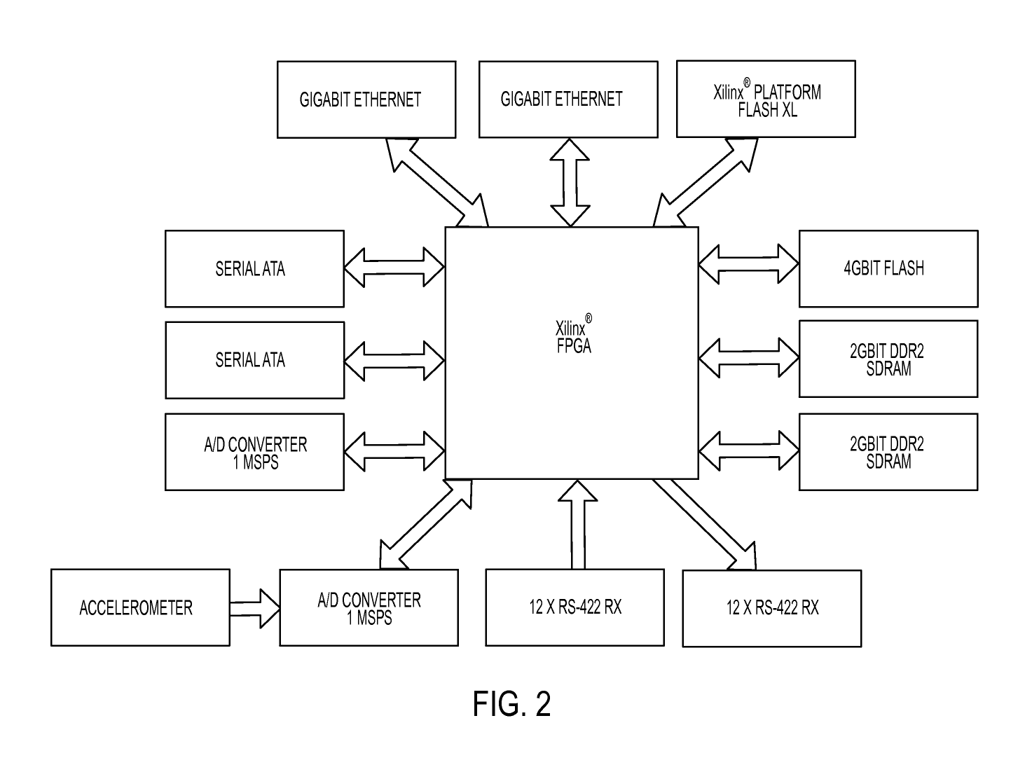

FIG. 2 is a schematic diagram illustrating an exemplary implementation of a processing system in accordance with the present teachings. The illustrated processor card includes a Xilinx® Virtex-5 FX100T FPGA non-space-rated FPGA including two IBM® PowerPC® processors, two Gigabit Ethernet interfaces (1 Gbps each) for recording to data drives, two Serial ATA (SATA) interfaces (1.5-3.0 Gbps) for recording to data drives, two multiplexed analog input channels such as the illustrated A/D converters that can run at, for example, 1 MSPS. The ND converters can provide an interface between various sensors and the FPGA such as, for example, an analog accelerometer or an analog video system (e.g., a RocketCam™, not shown). Legacy interfaces are also provided, such as 12 RS-422 RX interfaces for receiving data and 12 RS-422 TX interfaces for transmitting data. As stated above, these legacy interfaces can be space rated. Memory can include two two-gigabit DDR2 SDRAM (each of which can include two one-gigabit DDR2 SDRAM), a 4 Gbit Flash memory, and a Xilinx® Platform Flash XL. The 4 Gbit Flash memory is preferably space rated and stores application code for the FPGA, CPU, and DSP. The Xilinx® Platform Flash XL memory can store FPGA configuration files and application code. The application code can include code to compress data received from various cameras and sensors without losing data integrity. The compression code can be instrument specific.

In accordance with various embodiments of the present teachings, one or more of the above-described memories can be used to store the data and instructions necessary to carry out radiation hardening by software according to the present teachings. In an exemplary embodiment, the necessary scrubber functions and data corruption indicia are executed, for example, as background processes, for the processors, the FPGA, and the other elements of the modular computational component. It can therefore be beneficial to store at least a portion of the radiation hardening instructions in the memories associated with the devices for which scrubber functions and data corruption indicia are to be executable.

At least some of the illustrated interfaces can form an I/O portion of the processing system, allowing the processing system to connect with data connections of the external platform.

Interconnects (not shown) can be utilized as logical “glue” that connects the various components of the reconfigurable system. In certain exemplary embodiments, the interconnects can include, for example, standard J1 connectors for power and data channels. Standard J2 connectors can additionally be used. A reset logic can provide an appropriate control signal to the interconnects by managing inputs from internal/external hardware. The reset logic can include logic architecture configured to receive reset signals from at least one of a power manager, external hardware, internal hardware, and a software reset. The reset logic can output a signal to various processing system components when a reset is necessary, for example as part of the radiation hardening by software procedure.

A power source with voltage regulation (not shown) can be used to provide power to the processing system 100, and may be connected, for example, to a power distribution system of the external platform (not shown).

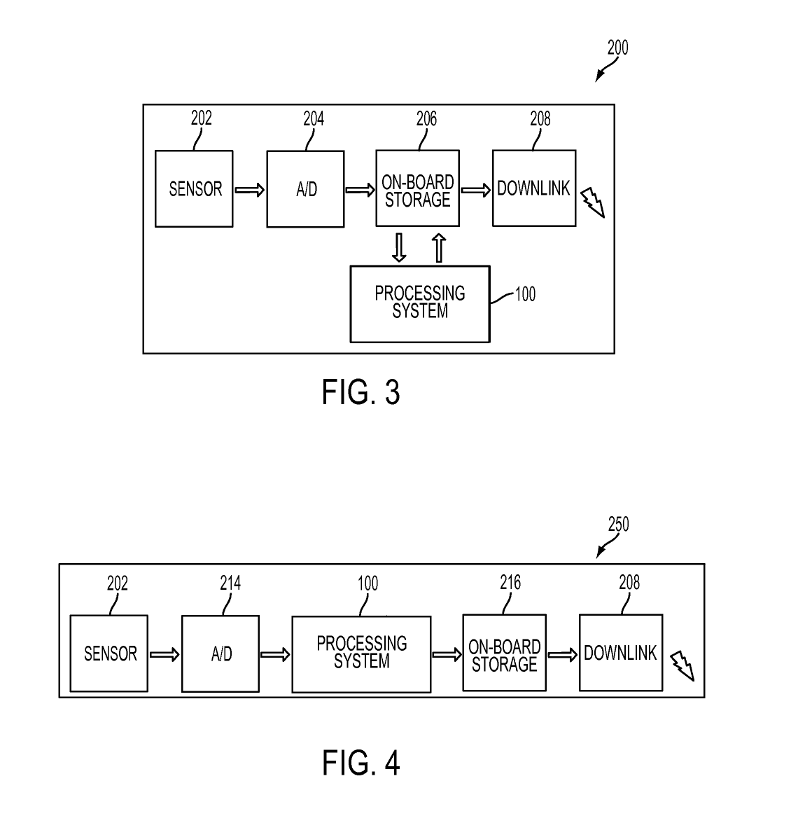

FIGS. 3 and 4 show exemplary system configuration schematic diagrams for integrating a processing system 100 according to the present teachings into the data flow of an external instrumentation platform. In a first configuration shown in FIG. 3, a parallel on-board data processor 200 utilizes a processing system 100 in parallel with the data stream through an on-board storage element 206, for example of a sounding rocket. In this configuration, one or more sensors 202 generate data, which goes through an ND converter 204 before reaching on-board storage 206. The processing system 100 is not directly in the data collection stream, but is connected to the on-board storage device 206 from which it can read raw data, execute desired algorithms, and generate desired products that can be stored back in the on-board storage 206. The processed data can then be retained in memory and/or transmitted via a downlink 208. In an exemplary embodiment, downlinking or transmission of data can be performed by one or more transponders at, for example, 10 Mb/s.

In the configuration illustrated in FIG. 3, processing can occur in near real-time, and upsets such as bit flip errors can be corrected by simply re-executing a processing step when an error is detected, for example by recognizing data corruption indicia, thus obtaining “perfect data” at the output. This configuration is well suited for use as a retrofit on existing sensor platforms, or on systems where data collection periods are followed at least by a minimal amount of idle time.

In a second system configuration for integrating a processing system 100, as shown in FIG. 4, the processing system 100 is connected in-line (serially) within the on-board data processor 250. Here, the processing system 100 is directly in the data stream of the device, for example, located between the A/D converter 214 and the on-board storage 216. This configuration may be better suited for instrument platform systems having strict real-time requirements for data processing, and/or extremely high data rates, where the volume of data has to be reduced prior to storage in the on-board storage 216.

The in-line configuration illustrated in FIG. 4 is capable of processing very high data rates, but can be subject to occasional errors, such as bit-flip errors or “bad pixel” errors due to radiation, if the data rate exceeds the recovery time for re-executing a processing step that is determined to be in error. In cases where the data rate is not extreme, and/or when there are some idle periods in the data collection stream, this configuration is also able to produce data with substantially no errors, by re-executing erroneous steps during the slower or idle periods.

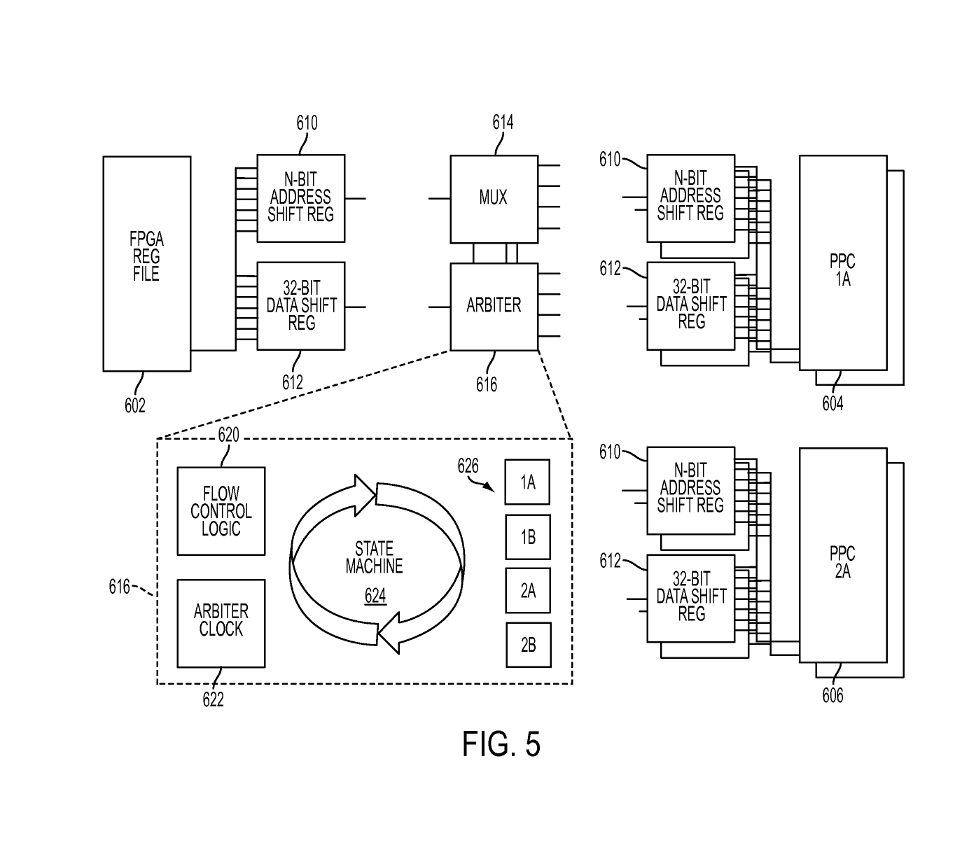

An exemplary embodiment of a memory map I/O according to the present teachings is shown in the block diagram of FIG. 5. The FPGA 400 can include a registry file 602 that is shown schematically connectable to a pair of PowerPC®s 604, 606. Each FPGA-to-PowerPC® connection can include a N-bit Address Shift register 610 and a 32-bit Data Shift Register 612. In the exemplary illustrated embodiment, a multiplexer 614 and an arbiter 616 are disposed between the FPGA and the two connected PowerPC®s 604, 606. A greater detail of the exemplary arbiter 616 is also shown. The arbiter 616 can include a state machine 624 operating on flow control logic 620 and an arbiter clock 622 on one side. The arbiter 616 can be used to provide the processors with access to shared memory.

In the illustrated exemplary implementations, the PowerPC® processors can be connected to each other by one or more universal asynchronous receiver/transmitters (UARTs, not shown) in a manner known to those skilled in the art.

When a serious fault due to radiation is discovered in a processing system providing radiation hardening by software, a reset architecture including a reset logic element can provide one or more paths to correct the fault. The reset logic element can be connected to the interfaces of the FPGA. Reset signals sent to the FPGA can include, for example, software reset commands, PowerPC® resets, logic resets, and program resets. The inputs to the reset logic element can include, for example, special command (SC) external resets and power card resets. The reset commands can originate, for example, from the radiation hardening software, from a command received from ground control (in the case of a sounding rocket), or from hardware of the external platform when a fault is discovered.

A processing system in accordance with the present teachings preferably provides compatibility with legacy power systems. An exemplary power distribution for a processing system according to the present teachings can include a power card providing power via a J1 connector of a compact PCI. The compact PCI can receive +28V power, for example, from a power supply from an external platform. From the compact PCI, power from the +28V source can be distributed as needed, for example, through consumer circuits providing +5V, +3.3V, +2.5V, +1.8V, +1.2V and +1.0V to specific elements of the processing system, as needed. The consumer circuits can include, for example, one or more of an L3 flash, a Flash Switch, a POL Converter, and a Virtex-5 Flash. Those of skill in the art will understand that different voltage distribution schemes can also be used within the scope of the present teachings.

A processor card in accordance with the present teachings provides increased processing power (each PowerPC® processor providing 1100 DMIPS) and interface capability while maintaining a small form factor (e.g., 4″×4″×3″, weighing 3 pounds) and backward compatibility. The processor card provides a stackable architecture allowing more that one processor card to be stacked to provide the power and functionality needed for a specific mission.

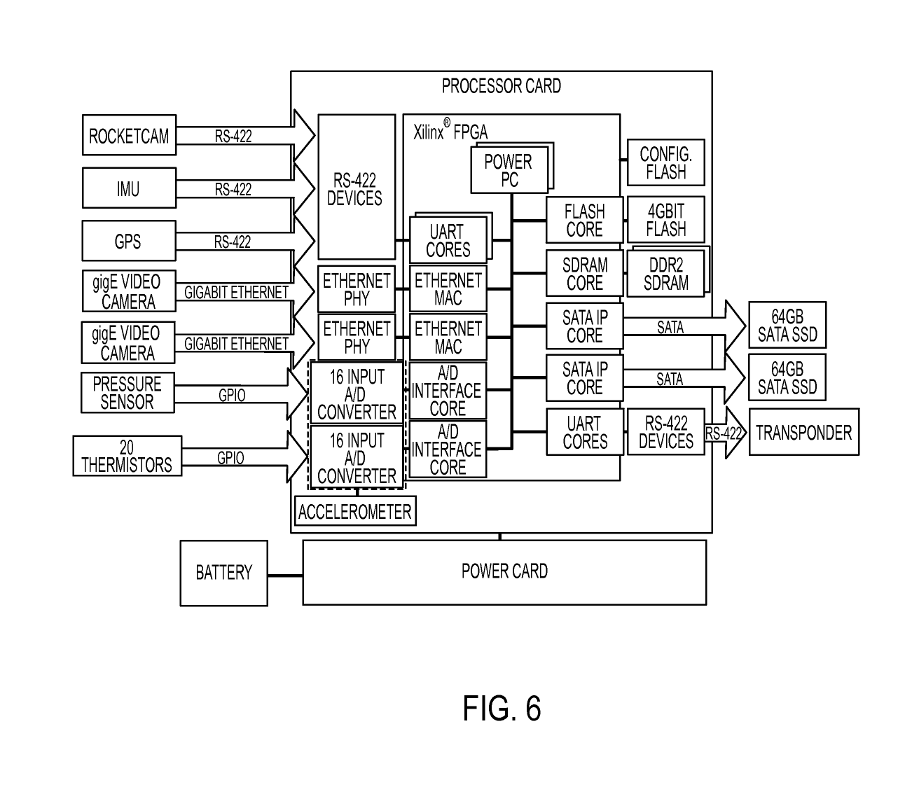

FIG. 6 illustrates an exemplary implementation of a processing system of the present teachings utilized in a sounding rocket payload. As shown, the processor card includes a Xilinx® Virtex-5 FX100T FPGA with two IBM® PowerPC® processors. Legacy RS-422 devices receive data from a RocketCam, an IMU, and a GPS, and are connected to the PowerPC® processors via UART cores. Two gigabit Ethernet interface connect GigE video cameras to the PowerPC® processors via Ethernet MACs, 16 input ND converters connect a pressure sensor to the PowerPC® processors via an ND interface core, and another 16 input ND converters connect thermistors and an accelerometer to PowerPC® processors via an A/D interface core. The 4 Gigabit Flash connects to the PowerPC® processors via a Flash core, the DDR2 SDRAM connects to the PowerPC® processors via an SDRAM core, and each SATA interface as its own SATA IP core. In the illustrated implementation, RS-422 devices are also used to connect a transponder for downlinking (transmitting data) to the PowerPC® processors via UART cores. The processor card receives power from a power card, as discussed above, the power card providing power from a battery.

The present teachings have been described with reference to specific exemplary embodiments. Other embodiments of the present teachings will be apparent to those skilled in the art from consideration of the specification and practice of the teachings disclosed herein. It is intended that the specification and examples be considered as exemplary only, with a true scope and spirit of the teachings being indicated by the following claims.

What is claimed is:

1. A processing system having a volume of less than about 4″×4″×3″ and configured to connect to an external platform, the processing system comprising:
input interfaces configured to receive an input signal to be processed, the input interfaces comprising at least one gigabit Ethernet interface and at least one space-rated balanced voltage digital interface circuit;
a radiation tolerant field programmable gate array comprising processors configured to process the input signal;
a first memory containing reconfigurable instructions for the processors that, when the reconfigurable instructions are executed, process the input signal and obtain the output signal;
output interfaces configured to send the output signal to the external platform, the output interfaces comprising at least one serial advanced technology attachment interface and at least one space-rated balanced voltage digital interface circuit; and
a reset logic element configured to selectively reset the field programmable gate array and at least one of the processors in response to a reset command.

2. The processing system of claim 1, wherein the first memory contains instructions that are reconfigurable after connection of the processing system to the external platform.

3. The processing system of claim 1, the processing system further comprising:
a second memory, wherein the second memory contains instructions to perform identical processing operations in each of the processors, compare data corruption indicia for the identical processing operations, and repeat the identical processing operations if the data corruption indicia disagree.

4. The processing system of claim 3, wherein the data corruption indicia comprise a checksum function.

5. The processing system of claim 3, wherein the second memory comprises instructions to execute a scrubber function.

6. The processing system of claim 5, wherein the scrubber function checks data from at least one of the processors.

7. The processing system of claim 5, wherein the scrubber function executes on one of the processors and an external platform processor.

8. The processing system of claim 1, the processing system further comprising:
an external platform processor connected to the field programmable gate array.

9. The processing system of claim 1, wherein the reset logic element comprises logic architecture configured to receive reset signals from at least one of a power manager, external hardware, internal hardware, and a software reset.

10. The processing system of claim 9, wherein the logic architecture receives the reset signals in response to an error detected in at least one of the processors.

11. The processing system of claim 9, wherein the reset signals received by the logic architecture comprise special commands from a station remote to the external platform.

12. The processing system of claim 1, wherein the external platform is a sounding rocket.

13. The processing system of claim 1, wherein the external platform is an unmanned air vehicle.

14. The processing system of claim 1, wherein the external platform is a miniaturized satellite for space research.

15. A method of providing increased processing power for a backward-compatible processing system having a volume of less than about 4″×4″×3″, the processing system being configured to connect to an external platform, the method comprising:
providing a first memory and a second memory;
providing a radiation tolerant field programmable gate array having two processors;
receiving data from the external platform using at least one gigabit Ethernet interface and at least one space-rated balanced voltage digital interface circuit;
processing the data from the external platform according to instructions stored in the first memory; and
outputting the processed data using at least one serial advanced technology attachment interface and at least one space-rated balanced voltage digital interface circuit.

16. The method of claim 15, the method further comprising:
executing instructions stored in the second memory to provide radiation hardening by software, the instructions to execute identical processing operations for the data from the external platform in each of the processors, instructions to identify a data corruption indicia for each of the identical processing operations, instructions to compare the identified data corruption indicia, and instructions to repeat the identical processing operations if the data corruption indicia show corrupted data.

17. The method of claim 16, the method further comprising:
issuing a reset command when the data corruption indicia show corrupted data.

18. The method according to claim 17, wherein issuing the reset command comprises issuing a reset signal to reset at least one of the processors.

19. The method according to claim 18, the method further comprising:
issuing the reset signal in response to a fault command from one of the processors, an external platform processor, and a software command.

20. A processing payload for a sounding rocket, the processing payload including a processing system having a volume of less than about 4″×4″×3″ and the processing payload comprising:
input interfaces configured to receive an input signal to be processed, the input interfaces comprising at least one gigabit Ethernet interface and at least one space-rated balanced voltage digital interface circuit;
a radiation tolerant field programmable gate array comprising processors configured to process the input signal;
memory containing reconfigurable instructions for the processors that, when the reconfigurable instructions are executed, process the input signal and obtain the output signal;
output interfaces configured to send the output signal to the external platform, the output interfaces comprising at least one serial advanced technology attachment interface and at least one space-rated balanced voltage digital interface circuit; and
reset logic configured to selectively reset the field programmable gate array and at least one of the processors in response to a reset command.
